(19) United States
(12) Patent Application Publication
(10) Pub. No.: US 2026/0015894 A1
(43) Pub. Date: Jan. 15, 2026

(54) MOTOR VEHICLE LOCK, IN PARTICULAR MOTOR VEHICLE DOOR LOCK

(71) Applicant: Kiekert Aktiengesellschaft, Heiligenhaus (DE)

(72) Inventors: Michael SCHOLZ, Essen (DE); Holger SCHIFFER, Meerbusch (DE); Peter SZEGENY, Engelskirchen (DE); Ömer INAN, Dorsten (DE)

(73) Assignee: Kiekert Aktiengesellschaft, Heiligenhaus (DE)

(21) Appl. No.: 18/992,769

(22) PCT Filed: May 31, 2023
(86) PCT No.: PCT/DE2023/100402

§ 371 Date: Jan. 23, 2025

(30) Foreign Application Priority Data
Jul. 13, 2022 (DE) 20 2022 103 943.7

(51) Int. Cl. E05B 81/14; E05B 81/06; E05B 81/30; E05B 81/42

(52) U.S. Cl. CPC E05B 81/14; E05B 81/06; E05B 81/30; E05B 81/42

(57) ABSTRACT

The invention relates to a motor vehicle lock, in particular a motor vehicle door lock, comprising a locking mechanism (1, 2) substantially including a rotary latch (1) and a pawl (2), and comprising an electromotive drive (4, 5, 6, 7, 8) which acts on both a release lever (3) for electrically opening the locking mechanism (1, 2) and substantially simultaneously on a security element (14, 15, 16) and also cooperates with a control element (9, 10, 11, 12, 13), wherein, when electrically opening the locking mechanism (1, 2) in the opening direction (EÖ) of the electromotive drive (4, 5, 6, 7, 8), the control element (9, 10, 11, 12, 13) transfers the security unit (14, 15, 16) at least temporarily into a control position opposite its starting position and it transfers same preferably back into its starting position when reversing said electromotive drive.

The invention relates to a motor vehicle lock, in particular a motor vehicle door lock, comprising a locking mechanism substantially including a rotary latch and a pawl, and comprising an electromotive drive which acts on both a release lever for electrically opening the locking mechanism and, substantially simultaneously on a security unit and also cooperates with a control element.

The motor vehicle lock is preferably a motor vehicle door lock, although the motor vehicle lock does not necessarily have to be used in connection with or on a motor vehicle door, but in principle other applications in or on the motor vehicle are also conceivable, for example on and in connection with a motor vehicle flap or the like. With such motor vehicle locks, and motor vehicle door locks in particular, the aim is always to equip the electromotive drive that is often used with as many functions as possible, as such electromotive drives are typically constructed in a cost-intensive manner. For this reason, it is intended to implement as many functions as possible within such a motor vehicle door lock by using a (single) electromotive drive.

Actually, the prior art according to WO 2019/076399 A1, for example, proceeds in such a manner that the electromotive drive is equipped with a drive element which operates directly or indirectly on the locking mechanism. In addition, the drive element interacts with at least one further element in a position-dependent manner, wherein the further element is a coupling element of an additionally realized mechanical operating lever chain. This already provides a compact, cost-effective and functional structure.

In the generic prior art according to WO 2021/115537 A1, it is possible to lock and unlock or open the locking mechanism simultaneously with the aid of the drive unit or the electromotive drive. The locking unit is usually used to prevent the locking mechanism from being opened manually.

In this way, a motor vehicle lock and in particular a motor vehicle door lock is provided which has a simplified structure and requires a smaller number of components compared to previous motor vehicle locks. In addition, it is intended to provide a cost-effective and structurally simple solution.

Generally, the state of the art has proven itself when it comes to implementing multiple functions with the help of the electromotive drive and, in this context, to ensure electrical opening of the locking mechanism and, for the most part, at the same time to transfer the security unit to its “secured” position or, in accordance with the generic teaching, to enable simultaneous locking of the operating lever. However, further improvements are possible and conceivable over this generic state of the art. Because, for the constructive implementation, the known teaching works together with both a control element and a control lever. In doing so, the control element is equipped as a component of the electromotive drive. The operating lever can be engaged with the release lever using the control lever.

The invention is based on the technical problem of further developing such a motor vehicle lock and in particular a motor vehicle door lock in such a way that the constructional effort is further reduced and a more compact structure is observed in comparison to the previous design.

To solve this technical problem, within the scope of the invention, a generic motor vehicle lock and in particular a motor vehicle door lock is characterized in that the control element, when the locking mechanism is opened electrically in the opening direction of the electromotive drive, at least temporarily transfers the security unit into its control position opposite to the starting position and, when reversing, preferably transfers it back to its starting position.

In this way, when the locking mechanism is opened electrically in the opening direction of the electromotive drive, the security unit is at least temporarily moved into the control position. In this case, the control position deviates from the starting position. For example, if the starting position is the “secured” position of the security unit, the control position corresponds to the opposite “unsecured” position. The reverse approach can be used just as well. In this case, the starting position may belong to the “unsecured” position, whereas the opposite control position then represents the “secured” position.

Such an approach has the general advantage that, for example, in the case of a security unit designed as an anti-theft unit or locking unit and the typically assumed starting position being “theft-proof” or “locked”, the electrical opening of the locking mechanism is associated with the security unit at least temporarily assuming the “not theft-proof” or “unlocked” position, so that the door can be opened without any problems. As soon as the electromotive drive is reversed, the security unit in question preferably returns to its starting position or is moved to the starting position with the help of the electromotive drive, specifically and in the example case described, to the “theft-proof” or “locked” position.

Comparable advantages are achieved if the security unit has initially assumed its “unsecured” or “not theft-proof” or “unlocked” position as the starting position and the electromotive drive is acted upon in its opening direction. In this case, the control element, which is actuated by the electromotive drive, ensures that the security unit is at least temporarily transferred to its functional position “secured” or, in the specific example, to the functional position “theft-proof” or “locked”. This has the consequence that during the electromotive opening process, the security unit is “secured” so that, for example, if a user were to simultaneously operate a manual handle, any malfunctions or collisions within the motor vehicle lock with the electromotive drive would not be observed.

Because, as soon as the security unit assumes its at least temporarily “secured” functional position, any additional operating lever chain provided for manually opening the locking mechanism is interrupted. This means that the actual electromotive opening process can run smoothly in both cases and there are no malfunctions or collisions with levers of a mechanical operating lever chain when additional manual action is applied. The additional and preferably realized procedure whereby the security unit is returned to its starting position when the electromotive drive is reversed also ensures that a type of “memory effect” is observed.

This is because the vehicle lock is returned to the state it was in before the electrical opening was initiated and started. If the security unit performs the described temporary change of state from the starting position to the control position when the locking mechanism is opened electrically, this change of state is generally uncritical since an associated vehicle door is opened anyway.

In addition, there is the advantageous possibility that the electromotive drive in its counter-opening direction can optionally move the security unit either into the starting position or the control position. This means that in the counter-opening direction to the opening direction of the electromotive drive taken in connection with the electrical opening of the locking mechanism, the security unit can be moved into its desired position independently of the electromotive drive. This can be either the “unsecured” or “secured” position. This depends on which starting position has been taken and into which position the security unit is then transferred.

In this way, the security unit can easily be operated as an electrical child safety unit. This means that, for example, after an electrical opening process of the associated motor vehicle door, it is possible for the relevant security unit or child safety unit to be moved to the desired position “unsecured” or “child-unsecured” as well as “secured” or “child-secured” via the electromotive drive. This is because after reversing the electromotive drive following such an electric opening process and accordingly when the vehicle door is closed, the electromotive drive can be operated in the counter-opening direction.

In this counter-opening direction, the security unit can be advantageously and optionally moved into the starting position or the control position. As a rule, it is not necessary to transfer the unit to the starting position because, preferably during reversing, the security unit has already been moved back to its starting position again. However, if this advantageous variant is not used, it is generally possible to move the security unit to both basic functional positions in the counter-opening direction using the electromotive drive. This means that the electromotive drive can act upon the security unit in the sense of “secured” as well as in the sense of “unsecured” in the counter-opening direction in question and independently of an electrical opening process.

This reduces the overall design effort because the electromotive drive is used as the only drive, on the one hand for electrically opening the locking mechanism and on the other hand for controlling and acting upon the security unit. As described, this avoids any malfunctions. These are the main advantages.

According to a further advantageous embodiment, the control element is generally provided with a 1st control contour and a 2nd control contour. The design is further such that the 1st control contour at least temporarily acts upon the security unit in the opening direction of the electromotive drive. In contrast, the 2nd control contour, usually in the counter-opening direction, ensures that the security unit is preferably permanently acted upon. This means that, by means of the 2nd control contour, the security unit is typically permanently acted upon in the counter-opening direction of the electromotive drive.

In most cases, the procedure is still such that both of the aforementioned control contours are connected to a common axis of the control element. Both control contours can be connected together to one actuating lever. In this context, it has also proven effective to act upon a 1st control contour of the control element using a 1st counter-contour of the drive and the 2nd control contour of the control element using a further 2nd counter-contour of the drive. The two counter- contours of the drive are generally arranged on the circumference of a driven pulley as a component of the drive. On the opposite side of the driven pulley, however, there is generally an actuating cam for acting upon the release lever.

In addition, the design is further such that a coupling element is realized as a component of the control element. The coupling element is advantageously guided in a coupling recess of the security unit. The coupling element can be a coupling pin which, in its “engaged” state, ensures that two operating levers are operatively connected to one another as components of an operating lever chain, so that a release lever is acted upon via the two operating levers and can be used to open the locking mechanism. To do this, the release lever typically works on the pawl and lifts it from its locking engagement with the rotary latch.

If, on the other hand, the coupling element or the coupling pin is in its functional position “disengaged”, the two operating levers are not operatively connected to one another and a corresponding action upon the operating lever chain is ineffective. Consequently, in this case the locking mechanism cannot be opened using the release lever.

As a result, a motor vehicle lock and in particular a motor vehicle door lock is provided, which is characterized by a particularly compact and functional design. First and foremost, this is due to the fact that the electromotive drive is a single drive. With the help of this single electromotive drive, the locking mechanism can be opened electrically and the security unit can be acted upon. The security unit itself can be designed as an anti-theft unit, a locking unit or even a child safety unit. In principle, combinations are also conceivable.

In this context, the security unit is particularly preferred as a child safety unit or an electrical child safety unit. Because, by means of the electromotive drive, the security unit or child safety unit in question can be optionally moved in the counter-opening direction to either of its two basic control positions, namely “unsecured” or “child-unsecured” as well as “secured” or “child-secured”. In principle, the security unit can of course also be a locking unit as well as an anti-theft unit.

All of this is achieved by taking into account a compact yet functional design, because the temporary change in state of the security unit during the electrical opening of the locking mechanism, first from the starting position to the opposite control position and then when reversing back again to the starting position during electrical opening, is not critical, since in this case the corresponding vehicle door is opened anyway. In fact, this approach corresponds to a kind of “ballpoint pen principle” in that a first action upon the security unit by the electromotive drive moves it from the start position to the control position, and then the next action upon the security unit by means of the electromotive drive (when reversing) moves the security unit again back to the start position. These are the main advantages.

In the following, the invention is explained in more detail with the aid of a drawing showing only an exemplary embodiment; in the figures:

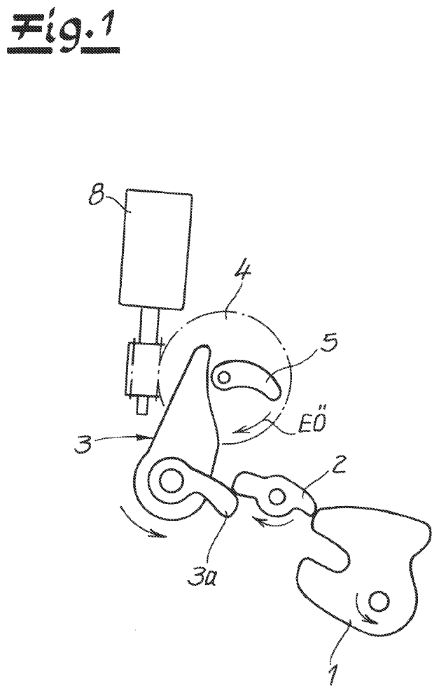

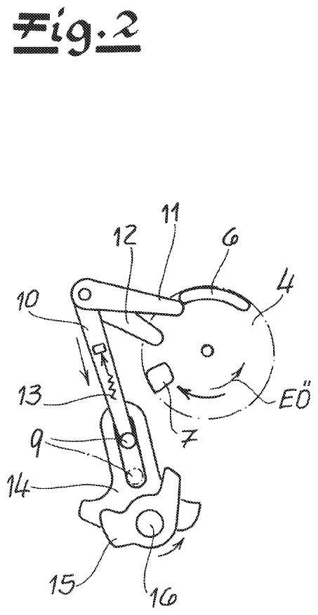

FIGS. 1 and 2 is the motor vehicle lock according to the invention and in particular the motor vehicle door lock in a front view (FIG. 1) and a rear view (FIG. 2), each reduced to the elements essential to the invention.

The drawings show a motor vehicle lock which, according to the exemplary embodiment, is a motor vehicle door lock. This has a locking mechanism 1, 2, which is only indicated in FIG. 1, consisting essentially of a rotary latch 1 and pawl 2. The locking mechanism 1, 2 is depicted in the closed state in the representation according to FIG. 1. Here, you can also see a release lever 3, which can be acted upon by means of an electromotive drive 4, 5, 6, 7, 8.

For this purpose, the electromotive drive 4, 5, 6, 7, 8 has a driven pulley 4 and an actuating cam 5 arranged on the driven pulley 4, which can be seen in the front view according to FIG. 1. The driven pulley 4 is set in rotation by means of an electric motor 8, which is only indicated. On the back side of the driven pulley 4, as can be seen in FIG. 2, a 1st counter-contour 6 and a 2nd counter-contour 7 are realized as components of the electromotive drive 4, 5, 6, 7, 8, which are explained in more detail below.

As already explained, the electromotive drive 4, 5, 6, 7, 8 can initially work on the release lever 3 for the electrical opening of the locking mechanism 1, 2. For this purpose, the electromotive drive 4, 5, 6, 7, 8 is acted upon in an opening direction EÖ indicated in FIG. 1 in the clockwise direction represented here by an arrow. This has the consequence that the actuating cam 5, which in the front view is connected to the driven pulley 4, is moved so far that, with the aid of the actuating cam 5, the release lever 3 is pivoted about its axis in the counterclockwise direction, which is also indicated in FIG. 1. In this way, the release lever 3 can act upon the pawl 2 with a release arm 3a, which is then lifted about its axis in a clockwise direction from the locking engagement with the rotary latch 1. As a result, the rotary latch 1 opens, in a spring-assisted fashion, in a counterclockwise direction, as also indicated in FIG. 1, and releases a locking bolt, not shown here. Then, the associated motor vehicle door can be opened.

In addition to the described electrical opening of the locking mechanism 1, 2, the electromotive drive 4, 5, 6, 7, 8 is also configured and able to act upon a security unit 14, 15, 16 for the most part simultaneously. For this purpose, the electromotive drive 4, 5, 6, 7, 8 can interact with a control element 9, 10, 11, 12, 13.

During the previously described electrical opening of the locking mechanism 1, 2 in the opening direction EÖ of the electromotive drive 4, 5, 6, 7, 8, the control element 9, 10, 11, 12, 13 transfers the security unit 14, 15, 16 at least temporarily into its control position opposite to the starting position and, when the electromotive drive 4, 5, 6, 7, 8 is reversed, preferably back again to its starting position.

For this purpose, the design is in detail first of all such that the control element 9, 10, 11, 12, 13 has a coupling element 9 as a component. The coupling element 9 is a coupling pin 9 which is guided in a recess or coupling recess of an operating lever 14 as part of the security unit 14, 15, 16, which can be seen in particular in FIG. 2. In addition to the operating lever 14, a further operating lever 15 is provided, both of which are mounted coaxially around a common axis 16 and together define the security unit 14, 15, 16.

If the coupling element or the coupling pin 9 is in the “disengaged” position shown in solid lines in FIG. 2, an action upon the operating lever 15 about the common axis 16 in the counterclockwise direction indicated here results in the operating lever 15 not being able to take the operating lever 14 along with it because the coupling pin 9 is “disengaged”. The functional position “secured” of the security unit 14, 15, 16 formed in this way corresponds to this.

If, on the other hand, the coupling element or the coupling pin 9 assumes the position indicated by the dot-dash line in FIG. 2 within the coupling recess of the operating lever 14 (“engaged”), the already described action upon the operating lever 15 in the anti-clockwise direction leads to the two operating levers 14, 15 being mechanically coupled to one another via the coupling pin 9 and consequently pivoting together about the common axis 16 in the indicated anti-clockwise direction. As a result, the two operating levers 14, 15 are also able to pivot the release lever 3, which is mounted coaxially about the axis 16, in an anti-clockwise direction, so that in this way the pawl 2 is lifted from its locking engagement with the rotary latch 1, as already described in the introduction. For this purpose, the two operating levers 14, 15 and the release lever 3 are mounted around the common axis 16.

The previously described security unit 14, 15, 16 is thereby acted upon overall by a control element 9, 10, 11, 12, 13. The coupling element or the coupling pin 9 represents a component of this control element 9, 10, 11, 12, 13. In addition, the control element 9, 10, 11, 12, 13 is also equipped with an actuating lever 10, which has a 1st control contour 11 and a 2nd control contour 12 on the end side. In addition, a spring 13 is realized which acts upon the actuating lever 10 and, according to the exemplary embodiment shown in FIG. 2, ensures that the actuating lever 10 is prestressed in the direction of the “disengaged” position of the coupling element or coupling pin 9. In fact, the coupling element or the coupling pin 9 is connected to one end of the actuating lever 10, whereas the two control contours 11, 12 are located at the other end and are arranged here.

The mode of operation is as follows. Starting from the closed position of the locking mechanism 1, 2 as depicted in FIG. 1, an action upon the electromotive drive 4, 5, 6, 7, 8 in the opening direction EÖ ensures that the pawl 2 is lifted from its latching engagement with the rotary latch 1 via the actuating cam 5 of the release lever 3. At almost the same time, the control element 9, 10, 11, 12, 13 ensures that the security unit 14, 15, 16 is acted upon. This corresponds specifically and in accordance with the representation in FIG. 2 to the process in which the 1st control contour 11, as part of the control element 9, 10, 11, 12, 13, is approached or acted upon via the 1st counter-contour 6 on the driven pulley 4. This is because the opening direction EÖ in the front view of FIG. 1 corresponds to a clockwise movement and accordingly in the rear view of FIG. 2 to a counterclockwise movement.

This results in the coupling pin 9 being moved from its previously assumed “disengaged” position, which is preloaded by means of the spring 13, to the “engaged” position. As a consequence of this, the control element 9, 10, 11, 12, 13 is transferred, during the described electrical opening of the locking mechanism 1, 2 in the opening direction EÖ of the electromotive drive 4, 5, 6, 7, 8, from the illustrated starting position “unsecured” of the security unit 14, 15, 16 or “disengaged” of the coupling pin 9 into a contrary control position and consequently “secured” and “engaged” of the coupling pin 9.

If the electromotive drive 4, 5, 6, 7, 8 is now reversed, the security unit 14, 15, 16 returns to its starting position or is transferred into this “secured” starting position. Because, when the electromotive drive 4, 5, 6, 7, 8 is reversed, the coupling element or the coupling pin 9—acted upon by the spring 13—again assumes its “disengaged” position. The change of state of the security unit 14, 15, 16 described in this way, initially temporarily from the “secured” position to the “unsecured” position and after reversing back to the starting position “secured”, is overall uncritical because the locking mechanism 1, 2 was opened by means of the electromotive drive 4, 5, 6, 7, 8 and consequently the associated motor vehicle door is open.

If, for example, the motor vehicle door is in its closed state and the locking mechanism 1, 2 also assumes its closed state as shown in FIG. 1, the electromotive drive 4, 5, 6, 7, 8 can transfer the security unit 14, 15, 16 in its counter-opening direction either into the starting position or the control position, that is to say specifically into the positions “secured” or “unsecured”. Since in the context of the exemplary embodiment the security unit 14, 15, 16 has already reached its “secured” position after reversing the electromotive drive 4, 5, 6, 7, 8, an additional approach to this position in the counter-opening direction is usually not necessary. Rather, starting from the position in FIG. 2, the “unsecured” position of the security unit 14, 15, 16 can be approached.

It corresponds to this that the 2nd control contour 12, as part of the control element 9, 10, 11, 12, 13, in the counter-opening direction in question, i.e. in FIG. 2 in a clockwise direction, preferably acts permanently upon the security unit 14, 15, 16. This is ensured by the 2nd counter-contour 7 of the electromotive drive 4, 5, 6, 7, 8, with the help of which the 2nd control contour 12 of the control element 9, 10, 11, 12, 13 is acted upon for this purpose.

This process corresponds specifically to the fact that the driven pulley 4 is acted upon in the counter-opening direction of the electromotive drive 4, 5, 6, 7, 8, consequently in the representation according to FIG. 2 in a clockwise direction. As a result, the 2nd counter-contour 7 of the electromotive drive 4, 5, 6, 7, 8 acts upon the 2nd control-contour 12 of the control element 9, 10, 11, 12, 13. Since the 2nd control contour 12 is designed as a two-arm lever that can be pivoted about an axis and is connected in an articulated manner to the actuating lever 10, the clockwise movement of the 2nd counter-contour 7 of the drive 4, 5, 6, 7, 8 causes the actuating lever 10 to be moved downwards against the force of the spring 13 by means of the 2nd control contour 12 and consequently the coupling pin 9 is transferred from its previously, in the starting position, occupied “disengaged” position and consequently “secured” position in the security unit 14, 15, 16 to the “engaged” position. As a result, the security unit 14, 15, 16 then assumes its functional position “unsecured” according to the dash-dotted representation in FIG. 2.

As soon as the electromotive drive 4, 5, 6, 7, 8 is acted upon in its opening direction EÖ, the 2nd counter-contour 7 moves back and releases the 2nd control contour 12, so that the actuating lever 10, acted upon by the spring 13, again moves upwards in the representation in FIG. 2 and the coupling pin 9 or the coupling element 9 is “disengaged” accordingly. As a result, the security unit 14, 15, 16 returns to its “secured” position. However, in doing so, the 1st counter-contour 6 has not reached the 1st control contour 11 of the control element 9, 10, 11, 12, 13. This is only the case when, in connection with the electrical opening of the locking mechanism 1, 2, the driven pulley 4 has covered such a large distance that the actuating cam 5 reaches the release lever 3. In this case the 1st counter-contour 6 of the electromotive drive 4, 5, 6, 7, 8 is able to act upon the 1st control contour 11 of the control element 9, 10, 11, 12,13.

This is because the opening direction EÖ of the electromotive drive 4, 5, 6, 7, 8 in the front view according to FIG. 1 corresponds to a counterclockwise movement in the rear view according to FIG. 2 and to the fact that after completing a corresponding pivoting path, the 1st counter-contour 6 of the electromotive drive 4, 5, 6, 7, 8 reaches the 1st control contour 11 of the control element 9, 10, 11, 12, 13 and moves the actuating lever 10 which is rigidly coupled to the 1st control contour 11 downwards against the force of the spring 13, so that the coupling element or the coupling pin 9 is moved from its previously assumed “disengaged” position to the “engaged” position.

As a result, the security unit 14, 15, 16 is at least temporarily transferred to its “unsecured” position, which is the opposite of the “secured” starting position. The subsequent and optional reversing of the electromotive drive 4, 5, 6, 7, 8 results, within the framework of the exemplary embodiment, in the security unit 14, 15, 16 being returned to its “secured” starting position, because the reversing movement of the driven pulley 4 corresponds to a 10 clockwise movement in the representation according to FIG. 2, so that the 1st counter-contour 6 leaves the 1st control contour 11 and the spring 13 can again return the coupling pin 9 to its “disengaged” position.

### LIST OF REFERENCE SIGNS

locking mechanism 1,2
rotary latch 1
pawl 2
release lever 3
release arm 3a
electromotive drive 4, 5, 6, 7, 8
driven pulley 4
actuating cam 5
1st counter-contour 6
2nd counter-contour 7
electric motor 8
control element 9, 10, 11, 12, 13
coupling element 9
coupling pin 9
actuating lever 10
control element 10
1st control contour 11
2nd control contour 12
spring 13
security unit 14, 15, 16
operating lever 14
operating lever 15
axis 16
opening direction EÖ

1. A motor vehicle lock, comprising:
a locking mechanism including a rotary latch and a pawl,
a release lever,
a security unit moveable between a control position and a starting position opposite from the control position,
an electromotive drive which acts on both the release lever for electrically opening the locking mechanism and simultaneously on the security unit, and
a control element,
wherein when electrically opening the locking mechanism in an opening direction of the electromotive drive, the control element transfers the security unit at least temporarily into thea control position opposite the starting position, and the control element transfers the security unit back into the starting position when reversing the electromotive drive.

2. The motor vehicle lock according to claim 1, wherein the electromotive drive moves in a counter-opening direction to transfer the security unit optinally into the starting position or the control position.

3. The motor vehicle lock according to claim 1, wherein the control element includes a first control contour and a second control contour.

4. The motor vehicle lock according to claim 3, wherein the first control contour in the opening direction of the electromotive drive at least temporarily acts on the security unit.

5. The motor vehicle lock according to claim 3, wherein the second control contour acts on the security unit when the electromotive drive moves in the counter-opening direction.

6. The motor vehicle lock according to claim 3,
wherein the control element further includes an actuating lever, and
wherein the first and second control contours are connected to an the actuating lever.

7. The motor vehicle lock according to claim 3,
wherein the electromotive drive includes a first counter-contour and a second counter-contour,
wherein the first control contour of the control element is acted upon by the first counter-contour of the electromotive drive and the second control contour of the control element by the second counter-contour of the drive.

8. The motor vehicle lock according to claim 7,
wherein the electromotive drive further includes a driven pulley having a circumference, and
wherein the first and second counter-contours of the electromotive drive are arranged on the circumference of the driven pulley.

9. The motor vehicle lock according to claim 1, wherein the control element includes a coupling element.

10. The motor vehicle lock according to claim 9,
wherein the security element includes a coupling recess, and
wherein the coupling element of the control element is guided in the coupling recess of the security unit.

11. The motor vehicle lock according to claim 6,
wherein the actuating level includes an axis, and
wherein at least one of the first and second control contours is connected to the axis.

12. The motor vehicle lock according to claim 11, wherein both the first and second control contours are connected to the axis of the actuating lever.

13. The motor vehicle lock according to claim 9, wherein the coupling element is a coupling pin.

14. The motor vehicle lock according to claim 1, wherein the release lever includes a release arm.

15. The motor vehicle lock according to claim 14, wherein the release arm is configured to lift the pawl of the locking mechanism to open the locking mechanism.
